(19) United States
(12) Patent Application Publication
(10) Pub. No.: US 2005/0228997 A1
(43) Pub. Date: Oct. 13, 2005

(54) Methods and devices for providing secure communication sessions

(76) Inventor: Dennis Dale Bicker, San Ramon, CA (US)

Correspondence Address: HARNESS, DICKEY & PIERCE, P.L.C., P.O. BOX 8910, RESTON, VA, 20195, US

(21) Appl. No.: 10/819,186

(22) Filed: Apr. 7, 2004

(51) Int. Cl. H04L 9/00

(52) U.S. Cl. 713/171

(57) ABSTRACT

A secure communication session between devices is provided by the reception of public keys by respective devices and the encoding/decoding of messages by the devices using the public keys and another private key.

### BACKGROUND OF TH INVENTION

The growth of cellular telephone use in personal communications services (PCS) has been rapid and widespread. Voice-over Internet Protocol (VoIP) capable telephones are also becoming increasingly popular. These modes of communication, however, can be subject to eavesdropping. Scanners can be used to intercept and/or record cellular telephone calls. On the Internet, hackers are an ever-present problem. Thus, potential users for whom confidentiality is paramount, e.g., doctors, lawyers and ministers, have been advised to avoid cellular and Internet-based telephony when engaging in confidential communications.

In response to such eavesdropping, secure communications solutions have been attempted. For example, one existing solution involves hard-wiring proprietary encryption processes into a telephone. Private computer networks also exist. These networks provide secure communications provided a communication takes place within the network.

It can be difficult, however, for an individual who does not have access to such a network to communicate securely with individuals who do, and vice-versa.

### SUMMARY OF THE INVENTION

In accordance with the present invention, methods and systems provide secure communication sessions between two or more devices by, for example: receiving, at a public key provider, an identification of an intended recipient's communications device and a request to forward a public key associated with the device from an initiating communications device; forwarding, from the public key provider, the public key associated with the recipient device to the initiating device; receiving, at the public key provider, an identification of the initiating device and a request to forward a public key associated with the initiating device from the recipient device; and forwarding, from the public key provider, the public key associated with the initiating device to the recipient, wherein the reception of the respective public keys by the initiating and recipient devices eventually enables the creation of a secure communication session between the devices.

In alternative embodiments, the public keys and requests are first routed through a gateway, when, for example, the two devices are operating using different technologies (e.g., wireless, Internet Protocol) or when a public key provider is operating using a different technology than either device.

Once either device has received a public key it may then encode or decode a communication message to or from the other device using the received public key and a separate, private key. Decoded messages may also be relayed to a non-secure device.

### BRIEF DESCRIPTION OF THE DRAWINGS

FIG. 1 depicts a simplified block diagram of a system for providing a secure communication session according to one embodiment of the present invention.

FIG. 2 depicts a simplified block diagram of a system for providing a secure communication session according to another embodiment of the present invention.

FIG. 3 depicts a flow diagram of some of the steps involved in the reception of public keys to enable the creation of a secure session according to one embodiment of the present invention.

FIG. 4 depicts another flow diagram of some of the steps involved in the generation of public keys according to one embodiment of the present invention.

### DETAILED DESCRIPTION OF THE INVENTION

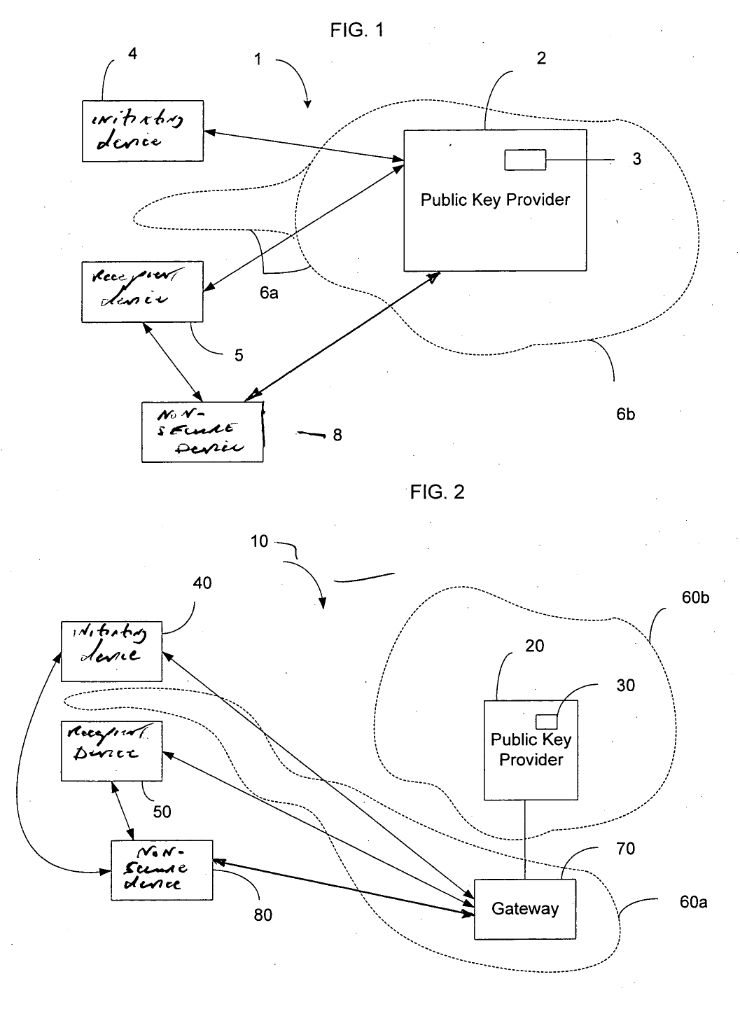

Referring now to FIG. 1, there is shown a system 1 for providing a secure communication session. The system 1 comprises a public key provider 2 which may comprise a database 3, an initiating device 4 (e.g., a device which is initiating a communication) such as a telephone, facsimile machine, computer or the like and a recipient device 5 (e.g., a device which is the intended recipient of the communication), which also may comprise a telephone. Each of the components of the system 1 may be a part of a network 6A or 6B. In one embodiment of the present invention, the network comprises a PCS network 6A. In yet another embodiment of the present invention, the network comprises an Internet-based network 6B.

System 1 provides secure communication sessions as follows. In one embodiment of the present invention, the public key provider 2 may be operable to receive an identification (e.g., telephone number, Internet address) associated with the recipient communications device 5 and a request to forward a public key associated with the device 5 from the initiating communications device 4. Said another way, the initiating device 4 sends the telephone number associated with the recipient device 5 to the public key provider 2. The initiating device 4 also sends a request to the provider 2 asking it to forward the public key associated with the recipient device 5 back to the initiating device 4. As is known by those skilled in the art, a public key is a type of code which can be used to scramble/encrypt and descramble/decrypt messages.

Once the public key provider 2 has received the identification and the request, it is operable to locate the public key associated with the recipient device 5 which may be stored within a database 3 or the like. Once the public key is located, the public key provider 2 is operable to forward the public key associated with the recipient device 5 to the initiating device 4.

In order for a secure communication session to be created between the initiating device 4 and recipient device 5, it is also necessary for the recipient device 5 to know the public key associated with the initiating device 4. That is, to create a secure session between the initiating device 4 and the recipient device 5, each of the respective devices must obtain the public key of the other respective device.

Continuing, after the public key provider 2 receives the request from the initiating device 4, it is operable to forward a notice or message (hereinafter “notice message”) to the recipient device 5 informing the device 5 that the initiating device 4 has requested a secure session, e.g., telephone call, email message, fax message, etc. . . . with the recipient device 5.

This notice message prompts the recipient device 5 to send its own identification and request to the public key provider 2.

Thus, in yet a further embodiment of the present invention, the public key provider 2 is operable to receive an identification (e.g., telephone number) associated with the initiating device 4, and a request to forward a public key associated with the initiating device 4, from the recipient device 5. Similar to before, upon receiving this identification and request the public key provider 2 is operable to locate the public key associated with the initiating device 4 stored within database 3 or the like. Once located, it is operable to forward the public key to the recipient device 5.

Reception of the respective public keys by the initiating and recipient devices 4, 5, in conjunction with the use of a private key eventually leads to the creation of a secure communication session between the two devices. One such a session is established, it is possible to send secure communication messages between the initiating device 4 and the recipient device 5 and to relay secure messages from or to a non-secure device 8. It should be noted that although the provider 2 stores public keys required by the devices 4, 5 in order to eventually create a secure session, the provider is not a part of any session that is created. That is, the provider is not involved in the transfer of messages between the devices 4, 5.

Referring now to FIG. 2, there is shown yet another embodiment of the present invention. FIG. 2 depicts a system 10, similar to the system 1 in FIG. 1 except that an additional component, called a gateway 70, has been added. In this embodiment of the present invention, the identification and requests which may be sent to the public key provider 20 are initially sent to the gateway 70 and then forwarded on to the public key provider 20. Likewise, the public keys that are stored in a database 30 and retrieved by the public key provider 20 are first forwarded to the gateway 70 and then forwarded on to either an initiating device 40 or recipient device 50. Those skilled in the art will recognize that the gateway 70 may be necessary, when, for example, the initiating device 40 is using different technology, e.g., Internet based technology, than is being used by the recipient device 50, e.g., a wireless technology, or when the provider 20 is using technology that is different from that being used by devices 40, 50. In such a case, gateway 70 is required to convert signaling and data protocols between the initiating device 40 and the recipient device 50, for example.

Once the initiating device 40 or recipient device 50 has received a public key associated with a respective device (e.g., when the initiating device 40 receives the public key associated with the recipient device 50 or vice-versa), either device may be operable to scramble, encode or encrypt (collectively “encode”) a message using the public key of the other device. Once an encrypted message is generated, it is sent on to the other device via traditional network devices (not shown). Similarly, to decode, descramble or decrypt (collectively referred to as “decode”) a communication message a device uses the received public key of the other device and its own private key. For example, the initiating device 40 may decode a communication from the recipient device 50 using the public key associated with the recipient device 50 it has received from the public key provider 20 along with a stored private key. Conversely, the recipient device 50 may decode a communication from the initiating device 40 using a public key associated with the initiating device 40 it has received from the public key provider 20 along with a stored private key. Though not shown in FIGS. 1 or 2, it should be understood that other network equipment is required to support a link between devices 4, 5. This equipment, however, is known to those in the art. A discussion of such equipment is not necessary for an understanding of the present invention.

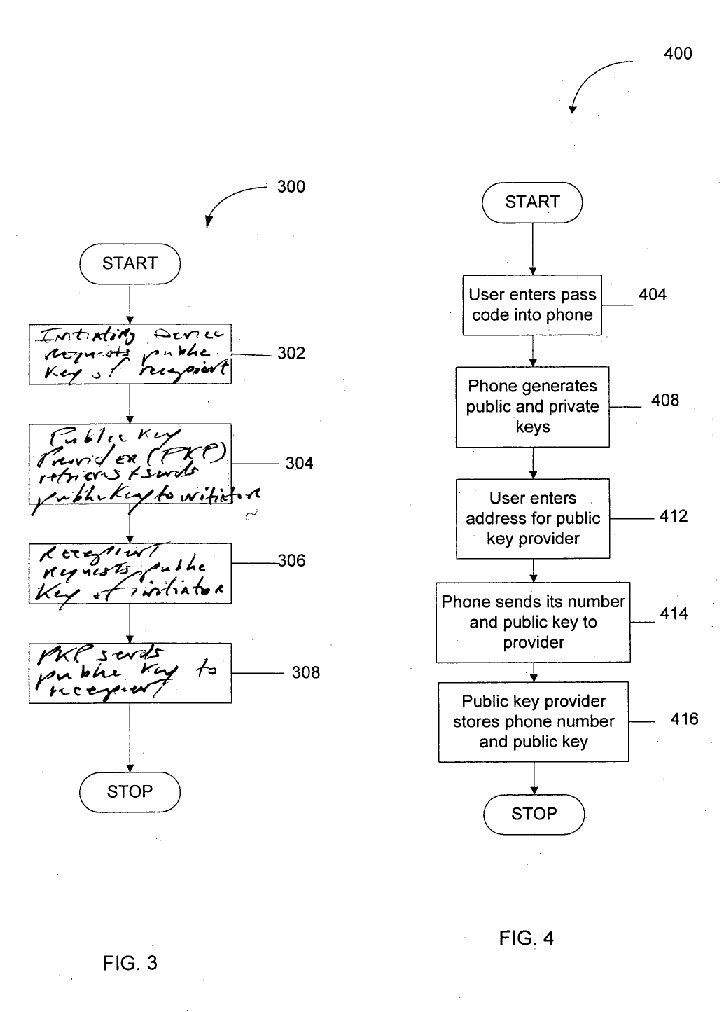

FIG. 3 depicts a simplified flow diagram of some of the steps just discussed above relating to the reception of public keys by devices 4, 5 or 40, 50 to enable the creation of a secure communication session.

In an additional embodiment of the present invention, before a public key provider can forward public keys, it must have first received such keys from devices, such as devices 4, 5, and 40, 50. In this embodiment, each of the devices may execute some initialization steps to forward its public key to a provider. For example, a device may be operable to receive a passcode from a user which permits the user to access the device. Once the passcode has been entered and verified, the device may be operable to enter a secure mode or the like during which it may generate public and private keys. After the generation of these keys, the device may be further operable to forward its public key to the public key provider directly or via a gateway. In a further embodiment of the present invention, prior to the forwarding of these keys, the user may prompt the device to send the public key to the provider by first entering in the identification or address of the public key provider. In either event, upon receiving the public key from the device, the provider is operable to store the public key in a memory or database.

The passcode discussed above may also be used to enter a secure mode after initialization. For example, each time a user requires a secure session, she may enter the passcode into device 4. Once validated, the device 4 is operable to enter a secure mode. Because the devices 4, 5 have previously forwarded their public keys to the provider 2, there is no need to do so again. Instead, the device 4, upon receiving a valid passcode is operable to forward a request for an intended recipient device's public key as described above.

FIG. 4 depicts another simplified flow diagram of some of the steps involved in the generation and storage of public keys as just described above.

It should be understood that the public keys which are generated by the initiating and recipient devices upon initialization of the devices are then stored by a public key provider so that the keys can be retrieved later on by either (opposite) device to eventually enable the creation of a secure communication session, as described previously above.

The above discussion has sought to set forth some of the examples of the present invention. Others are possible. For example, the networks 6a, 6b, 60a, 60b shown in FIGS. 1 and 2 may be Internet, voice switched, PCS, wireless or VoIP networks to name just a few examples. In addition, either an initiating or recipient device may receive information about the other device via a caller identification data link or the like.

In a further embodiment of the present invention, the systems 1, 10 shown in FIGS. 1 and 2 may include one or more additional devices 8, 80. These devices may not be capable of encoding or decoding messages. Nonetheless, in an additional embodiment of the present invention, a message may be encoded or decoded by a device 4, 5 or 40, 50 or public key provider 2, 20, and then relayed on to device 8, 80 (in the case of a decoded message) or on to a secure device (in the case of an encoded message). Devices which are capable of encoding and decoding communications may be referred to as secure devices while devices 8, 80 may be referred to as non-secure devices. For example, non-secure device 8 may send an unsecure message (i.e., one that is not encoded) to public key provider 2. Upon receiving the message, provider 2 may be operable to encrypt the message using the public key of an intended recipient device or of the non-secure device 8 and forward it on to traditional network devices which will deliver the encrypted message to an intended recipient secure device, such as device 4. In the reverse direction, provider 2 may be operable to receive an encoded message from device 4, decrypt it using the public key associated with the secure device 4 or non-secure device 8, and then forward it on the non-secure device 8. In this manner, at least part of the session will be secure.

The above described systems and methods provide relatively simple ways for users to engage in secure communication sessions over the Internet and/or via a PCS network, for example. Once a public key provider has provided public keys to an initiating device and/or recipient device a secure session may subsequently be established. When both parties have secure devices (wired or wireless telephones, facsimile machines, personal digital assistants, computers, etc.), there is no need for an intermediary or agent to provide security during a secure communication session, e.g., throughout a secure telephone call.

It should be understood that the features and functions of the devices and public key providers shown in FIGS. 1 and 2 may be carried out, or controlled by (collectively “controlled”), by hardware, firmware, or software embedded in such devices and providers, for example, in a computer readable medium (e.g., microprocessor, digital signal processor, memory devices, floppy disc, etc.) made a part of devices 4, 5, 40, 50 and providers 2, 20. The software or firmware may comprise one or more programs.

The signals sent to/from the providers 2, 20 may also fall within the scope of the present invention. For example, an encoded communications signal embodied in a modulated carrier wave and representing sequences of instruction to instruct a public key provider to carry out the features and functions described above, are intended to fall within the scope of the present invention.

The above has set forth some examples of the present invention. The true scope of the present invention is better defined by the claims which follow.

1. A method for providing a secure communication session comprising:
receiving, at a public key provider, an identification associated with an intended recipient communication device and a request to forward a public key associated with the device from an initiating communication device;
forwarding the public key associated with the recipient device to the initiating device;
receiving an identification associated with the initiating device and a request to forward a public key associated with the initiating device from the recipient device; and
forwarding the public key associated with the initiating device to the recipient device,
wherein the reception of the respective public keys by the initiating and recipient devices eventually enables a secure communication session to be created between the two devices.

2. The method as in claim 1 further comprising forwarding, from the public key provider, a notice message to the recipient device informing such a device that the initiating device has requested a secure communication session with said recipient device.

3. The method as in claim 1 further comprising:
initially receiving the identification associated with the recipient communication device and the request to forward the public key associated with the recipient device at a gateway; and
forwarding the identification associated with the recipient communication device and the request to forward the public key associated with the recipient device to the public key provider from the gateway.

4. The method as in claim 1 further comprising:
initially forwarding the public key associated with the recipient device to a gateway from the public key provider; and
forwarding the public key associated with the recipient device to the initiating device from the gateway.

5. The method as in claim 2 further comprising:
initially forwarding the notice message to a gateway from the public key provider; and
forwarding the message from the gateway to the recipient device.

6. The method as in claim 1 further comprising:
initially receiving the identification associated with the initiating device and the request to forward a public key associated with the initiating device at a gateway; and
forwarding the identification associated with the initiating device and the request to forward the public key associated with the initiating device to the public key provider from the gateway.

7. The method as in claim 1 further comprising:
initially forwarding the public key associated with the initiating device to a gateway from the public key provider; and
forwarding the public key associated with the initiating device to the recipient device from the gateway.

8. A method for providing a secure communications session comprising:
encoding, at a public key provider, a message from a non-secure device; and
forwarding the encoded message on to a secure device.

9. A method for providing a secure communications session comprising:
decoding, at a public key provider, a message from a secure device; and
forwarding the decoded message to a non-secure device.

10. A method for providing a secure communication session comprising:
forwarding, from an initiating device, an identification associated with an intended recipient communications device and a request to forward a public key associated with the device;
receiving the public key associated with the recipient device at the initiating device; and
decoding, at the initiating device, a message from the recipient device using the received public key and a private key.

11. The method as in claim 10 further comprising relaying the decoded message to a non-secure device.

12. A system for providing a secure communication session comprising:
a public key provider operable to;
receive an identification associated with an intended recipient communication device and a request to forward a public key associated with the device from an initiating communication device,
forward the public key associated with the intended recipient device to the initiating device,
receive an identification of the initiating device and a request to forward a public key associated with the initiating device from the recipient device, and
forward the public key associated with the initiating device to the recipient device,
wherein the reception of the respective public keys by the initiating and recipient devices eventually enables the creation of a secure communication session between the two devices.

13. The system as in claim 12 wherein the public key provider is further operable to forward a notice message to the recipient device informing such a device that the initiating device has requested a secure communication session with said recipient device.

14. The system as in claim 12 further comprising a gateway operable to:
initially receive the identification of the recipient communication device and the request to forward the public key associated with the recipient device; and
forward the identification of the recipient communication device and the request to forward the public key associated with the recipient device to the public key provider.

15. The system as in claim 12 wherein:
the public key provider is further operable to initially forward the public key associated with the recipient device to a gateway; and
the gateway is operable to forward the public key associated with the recipient device to the initiating device.

16. The system as in claim 12 wherein:
the public key provider is further operable to initially forward the notice message to a gateway; and
the gateway is further operable to forward the message to the recipient device.

17. The system as in claim 12 further comprising:
a gateway, operable to initially receive the identification associated with the initiating device and the request to forward a public key associated with the initiating device, and
forward the identification associated with the initiating device and the request to forward the public key associated with the initiating device to the public key provider.

18. The system as in claim 12 wherein:
the public key provider is further operable to initially forward the public key associated with the initiating device to a gateway; and
the gateway is operable to forward the public key associated with the initiating device to the recipient device.

19. A public key provider for providing a secure communications session operable to encode a message from a non-secure device and forward the encoded message on to a secure device.

20. A public key provider for providing a secure communications session operable to decode a message from a secure device and forward the decoded message to a non-secure device.

21. A system for providing secure communications comprising:
a first communication device, operable to forward an identification of a second communication device and a request to forward a public key associated with the second device,
receive the public key associated with the second device to enable the creation of a secure communication session with the second device, and
decode a communication from the second device using the received public key and a private key.

22. The system as in claim 21 wherein the first or second device is further operable to relay a decoded communication to a non-secure device.

23. The system as in claim 21 wherein the first and second devices are selected from the group consisting of at least wired or wireless: telephones, facsimile machines, personal digital assistants and computers.

24. A computer readable medium for providing a secure communication session operable to control:
forwarding of an identification associated with an intended recipient communications device and a request to forward a public key associated with the device;
reception of the public key associated with the recipient device; and
decoding of a message from the recipient device using the received public key and a private key.

25. The computer readable medium as in claim 24 further operable to relay the decoded message to a non-secure device.

26. A computer readable medium for providing a secure communication session operable to control:
reception of an identification associated with an intended recipient communication device and a request to forward a public key associated with the device from an initiating communication device,
forwarding the public key associated with the intended recipient device to the initiating device,
reception of an identification of the initiating device and a request to forward a public key associated with the initiating device from the recipient device, and
forwarding the public key associated with the initiating device to the recipient device,
wherein the reception of the respective public keys by the initiating and recipient devices eventually enables the creation of a secure communication session between the two devices.

27. The computer readable medium as in claim 26 further operable to control the forwarding of a notice message to the recipient device informing such a device that the initiating device has requested a secure communication session with said recipient device.

28. A computer readable medium for providing a secure communications session operable to control encoding a message from a non-secure device and forwarding the encoded message on to a secure device.

29. A computer readable medium for providing a secure communications session operable to control decoding a message from a secure device and forwarding the decoded message to a non-secure device.

30. An encoded communications signal embodied in a modulated carrier wave and representing sequences to instruct a public key provider to:
receive an identification associated with an intended recipient communication device and a request to forward a public key associated with the device from an initiating communication device,
forward the public key associated with the intended recipient device to the initiating device,
receive an identification of the initiating device and a request to forward a public key associated with the initiating device from the recipient device, and
forward the public key associated with the initiating device to the recipient device,
wherein the reception of the respective public keys by the initiating and recipient devices eventually enables the creation of a secure communication session between the two devices.
